(19) United States
(12) Patent Application Publication
(10) Pub. No.: US 2007/0172553 A1
(43) Pub. Date: Jul. 26, 2007

(54) Packaged bread snack

(76) Inventors: Firdevs Bas, Vlaardingen (NL); Markus Dachtler, Vlaardingen (NL); Petrus Maria De Kok, Vlaardingen (NL); Michel Mellema, Vlaadingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/557,568

(22) PCT Filed: May 5, 2004
(86) PCT No.: PCT/EP04/04888

§ 371 Date: Dec. 18, 2006

(30) Foreign Application Priority Data
May 26, 2003 (EP) 03076610.9

(51) Int. Cl. A21D 13/00

(52) U.S. Cl. 426/94; 426/106

(57) ABSTRACT

A packaged bread snack, comprising a package having therein a piece of bread which is cut into two halves and having a filling situated between the halves, said filling comprising one or more types of vegetables and one or more ingredients chosen from the group consisting of cheese, fish, meat and pesto, further comprising a fat encapsulated flavour. The snack has a freshness which persists during a period of more than 24 hours, up to four days.

### TECHNICAL FIELD

The present invention relates to food products. Specifically, it relates to a bread snack, more in particular a packaged bread snack.

### BACKGROUND ART

In modern society, there is an increasing trend that meals are no longer exclusively taken at home and at fixed times of the day. An example is the consumption of bread snacks with a tasty filling which are sold in snack bars, waiting rooms, office restaurants, petrol stations, etc. Such bread snacks may be prepared on demand using ready baked bread and provided with a fresh filling of cheese, fish or meat ingredients, often in combination with various kinds of vegetables, and they are highly appreciated by the consumers.

Whereas some snack bars offer freshly prepared bread snacks, one often encounters pre-fabricated bread snacks which are offered in a packaged take-away form and which are especially practical for hurried people. In contrast to the freshly prepared bread snacks, the quality of packaged bread snacks is usually found to be rather disappointing.

Wrapping some plastic foil around the snack is the common method for attempting to preserve its freshness. This measure, however, is insufficient for preserving freshness for more than a few hours, particularly when the bread snack has a filling of meat and vegetables.

Thus, packaged bread snacks, particularly when stored under cooled conditions, quickly loose their freshness and taste & flavour quality and appearance, usually within one day after the preparation of the snack. This process of deterioration is generally accepted as unavoidable for packaged bread snacks that are not prepared on the day of consumption. It has been found that the presence of olive oil in bread has an advantageous effect on the freshness of bread snacks prepared with such bread.

WO-A-02/096207 (Unilever) discloses a cooled packaged bread snack, comprising a package having therein a piece of bread which is cut into two halves and having a filling situated between the halves, said filling comprising one or more types of vegetables and one or more ingredients chosen from the group consisting of cheese, fish, meat and pesto.

It is an object of the present invention to provide a packaged bread snack, which has even further improved organoleptic properties, in particular, an improved freshness and taste and flavour perception after storage for one or more days. Surprisingly, this object could be achieved by the packaged bread snack of the present invention, which is characterized in that it comprises flavour particles, encapsulated with a fatty material. Preferably, the flavour is a bread flavour.

Commercially available flavours (e.g. bread flavour, basil flavour) leave to be desired with regard to stability or the flavour release in the product. Such flavour delivery systems are described by Uhlemann et al. in: Perfumer and Flavorist 27, 52-61 2002. US 2002/0192352 McCormick & Company) discloses encapsulates of e.g. flavours in high melting point fats.

However, such encapsulates are generally not regarded as stable in products such as bread snacks which have a high water activity (aw>0.9).

### SUMMARY OF THE INVENTION

In a first aspect, there is provided a packaged bread snack, comprising a package having therein a piece of bread which is cut into two halves and having a filling situated between the halves, said filling comprising one or more types of vegetables and one or more ingredients chosen from the group consisting of cheese, fish, meat and pesto, characterized in that it comprises flavour particles, encapsulated with a fatty material.

In a second aspect, there is provided a method for manufacturing such a packaged bread snack.

### DISCLOSURE OF INVENTION

In the context of this patent the term bread snack will be generally used for a relatively small piece of bread, usually denoted as sandwiches, rolls etc., which has been prepared with a tasty filling. These fillings comprising one or more ingredients chosen from the group consisting of cheese, fish, meat and pesto and one or more kinds of fruits and vegetables, one of which is lettuce. The packaged bread snacks, which are the object of the present invention, are prepared with ingredients, which are quite sensitive to withering and fading.

Generally, the meaning of freshness varies with the type of food product. Some kinds of food have lost their freshness already the day after harvesting or preparation (cooking or baking), others remain fresh for several days or even longer, but always for a limited time. Freshness by its nature is a temporary property of a food product.

Bread is a product that is preferably consumed within 24 hours after baking. Already after one day the staling process becomes noticeable. The freshness related aspects such as texture, firmness and resilience of the crumb can be easily tested by softly pressing the bread, and when not satisfactory, the snack is practically unsellable. Bread snacks when prepared with a filling tend to loose their freshness even earlier because moisture from the filling ingredients migrates into the bread. For hygienic reasons bread snacks are stored under cooled conditions, which, however, accelerate the staling process.

In this specification the freshness property of a bread snack is defined as being present when the appearance and the taste of the bread snack do not substantially differ from those of a similar snack but prepared and packed at the day of the freshness assessment. The freshness property particularly includes the tactile perception caused by said soft pressing the breadcrumb.

The appeal to a prospective consumer of the present bread snack is based on its healthy, colourful and particularly fresh appearance. To obtain such appeal the usual one-day freshness of conventional bread snack had to be prolonged, preferably up to four days after its preparation. This would allow a reasonable shelf life for a selling point where daily change of stock is not possible. The development, however, of such a packaged bread snack with prolonged freshness was a serious challenge.

It was found that the incorporation of flavour particles, which are encapsulated with a fatty material (e.g. bread flavour, basil flavour) remarkably improves the taste and flavour perception, so that is remains fully acceptable to the consumer for several days.

The fatty material has a melting point in the range of 25-160° C., preferably from 30-40°C. In this way, the fat encapsulated flavour is kept in a water free barrier and therefor protected during the storage of the bread under cooled conditions. When the product is consumed, part of the fat encapsulates start to melt in the mouth and the flavour is also released by the additional destruction of the fat barrier of the flavour encapsulates during the eating process.

In principle any suitable fatty material can be used for the fat encapsulated flavour of the present invention, provided that the melting point is in the indicated range of 25-160° C., preferably from 30-40° C.

By melting point we mean in the context of this application the slip melting point, described in the ISO Standard 6321:2002.

Preferably the fatty material has a percentage solid fat content at 20° C. of at least 30, preferably at least 40, even more preferably more than 60. The percentage solid fat content at a given temperature can be determined by pulse NMR according to the method described by van den Enden et al., Fette Seifen, Anstrichm. 80, 180 (1978) and van den Enden et al., J. Amer. Oil Chem. Soc. 59,433 (1982). It is usually expressed as the n value, e.g. n20 is the percentage solid content at 20° C. Preferably the fatty material has a percentage solid content at 50° C. of less than 10, preferably less 5.

Examples of suitable fatty materials are triglycerides, wax esters, sterols, sterol esters, hydrocarbons and mixtures thereof. Examples of triglycerides are hydrogenated or fractionated vegetable oils such as hydrogenated palm oil, hydrogenated palm kernel oil, hydrogenated cotton seed oil, hydrogenated rape seed oil, hydrogenated soy bean oil, hydrogenated sunflower oil, hydrogenated peanut oil and mixtures thereof.

Another requirement is that the fatty material itself must not have any unpleasant organoleptic properties such as an unpleasant taste.

Suitable flavours are any commercially available flavour, for example powdered bread, basil, herb, cheese, olive, pesto, tomato, sun dried tomato, fish, e.g. salmon, tuna or meat flavour. Preferred cheese flavours are mozzarella, Parmesan, Gorgonzola or Pardena flavour.

An especially preferred flavour is bread flavour. Suitable encapsulation systems are described by Uhlemann et al., (Perfumer and Flavorist 27, 52-61 2002) and in US 2002/0192352 (McCormick & Company). An example of such a commercially available bread flavour is 611049H from Givaudan.

The flavour particles usually comprise a carrier for the flavour material, for example maltodextrin. The particle size of the flavour particles is from 0.01 mm to 10 mm, preferably from 0.1 to 5 mm, more preferably from 0.5 to 1 mm.

The packaged bread snack preferably is prepared with “Italian” bread, more preferably ciabatta bread. For the present snack a soft crust variant is chosen. The traditional recipes for ciabatta bread contain olive oil, preferably virgin olive oil. The bread contains 0.1-10% of olive oil calculated on the dry matter of the bread, preferably 0.5-8%, more preferably 1-6%. A suitable amount is about 6% of olive oil. The olive oil may be supplemented by another suitable vegetable oil. Preferred oils are here sunflower oil, sesame oil or nut oil.

Focaccia bread like ciabatta bread originates from Italy and its composition comprises typical herbs. Recipes for ciabatta and focaccia bread dough are well known or easily accessible to the skilled baker. The focaccia herbs, when added to the ciabatta dough have a favourable effect not only on the taste but also on the freshness of the packed bread snack.

The dough used for preparing the snack bread further contains the usual ingredients for bread preparation. The addition of bakery emulsifiers, particularly diacetyl tartaric acid esters of glycerides (DATA) and/or diacetyl tartaric acid esters of monoglycerides (DATEM), further improves the prolonged freshness condition. Preferred amounts of DATA and/or DATEM are 0.05 to 0.5%, preferably 0.1 to 0.3%.

Other emulsifiers known in the art may be added in addition to DATEM and/or DATA. Examples of such emulsifiers are mono- and/or diglycerides, polyoxyethylene stearates, sugar esters of fatty acids, polyglycerol esters of fatty acids, lactic acid esters of monoglycerides, acetic acid esters of monoglycerides, lecithins or phospholipids.

A dough used in the invention will generally comprise flour, water and one or more leavening agents. Examples of suitable flours are soy flour, whole meal, wheat flower, high gluten flour or combinations thereof. Suitable leavening agents are yeast, baking powder, sodium carbonate and sodium hydrogen carbonate.

The amount and ratio of flour, water and leavening agent can be easily determined by the person skilled in the art depending on the type of bread to be prepared. A typical dough according to the invention comprises 45-70 wt % of flour, 45-20 wt % of water and up to 10 wt % of leavening agent.

In accordance with established baking practice the dough may comprise one or more further components selected from the group consisting of: seeds, nuts, dried raisins, sultanas, milk powder, gluten, granulated fat, anti-oxidant (e.g. ascorbic acid, potassium bromate, potassium iodate, ammonium persulfate), amino acids (e.g. cysteine), a salt chosen from the group consisting of sodium chloride, calcium acetate, sodium sulfate, calcium sulfate, calcium carbonate, sodium carbonate and sodium hydrogen carbonate, sugar, colourants, preservatives and flavours.

The bread for the packaged snack according to the invention can be prepared by first mixing and kneading the dough ingredients except the oil. Then the oil is added to the mixture, preferably in the last three minutes of the kneading step. Preferably the kneading lasts at least 5 minutes. Then the dough is proofed, formed, allowed to rest, optionally pricked and cut, proofed, pre-baked, cooled, blast frozen and baked.

The bread when taken from the oven is allowed some cooling time before it is prepared with the filling and packed. For hygienic reasons cooled storage conditions are applied.

The filling of the snack comprises one or more kinds of vegetables, one of which always is a leaf of lettuce. Further ingredients are chosen from the group consisting of cheese, fish, meat and pesto. Preferably, the ingredients composition is chosen such that it supports the “Italian” image of the snack. Suitable fillings are various kinds of salads, pesto, tuna, smoked fish, cheese, tomato, paprika, aubergines, cucumber, spreads, mayonnaise, ham, chicken, prawns, herbs, spices, or combinations thereof.

The choice of a proper package form considerably contributes to the improved fresh appearance of the final packed bread snack. Preferably a package is chosen which is shaped as an at least partially transparent, shallow tray, for the major part consisting of a stiff, rigid material, preferably a thermoformed polyethylene polyester plastic. A suitable package has been described in WO-A-02/096207 (Unilever). It protects the soft and pressure sensitive snack in the display against undesirable touching and squeezing for proof of freshness.

After filling the tray with the prepared snack, it is sealed at its back side by a plastic foil which preferably has a dark colour and so provides a contrasting background for the inside snack. The sealed package effectively protects the snack against microbiological contamination and drying and guarantees that the package has not been opened after production.

Often freshness quality is outwardly judged by the appearance of the vegetables, particularly of the lettuce leaf. Therefore and for an attractive showing up in the shop's display, the filling is arranged preferably such that the contents, at least partially, are clearly visible through the transparant package.

The snack's freshness persists during a period of more than 24 hours after the snack's preparation. Preferably the bread snack has a freshness which persists during a period of at least two days, preferably at least three days, more preferably at least four days after the snack's preparation.

Unless otherwise stated, percentages abbreviated in this specification indicated with “wt %” refer to weight percentages. Percentages indicated with “%” are meant to refer to weight percentages based on the total amount of flour and meal used unless stated otherwise. This amount equals to the dry matter content of bread when the dough has been baked.

The invention will now be illustrated by the following non-limiting examples.

### EXAMPLE 1

### Dough compositions

The following dough composition was prepared:

TABLE 1

| | | wt. % based on |
|---|---|---|
| | | total amount of |
| Ingredient | Gram | flour |
| Flour (ex Ibis) | 2000 | 100 |
| Yeast | 72 | 3.6 |
| Water | 1180 | 59.0 |
| Olive oil | 120 | 6.0 |
| Salt | 44 | 2.2 |
| Sunflower oil | 12 | 0.6 |
| Sugar | 20 | 1.0 |
| Gluten | 40 | 2.0 |
| Soy flour | 10.000 | 0.5000 |
| Ascorbic acid | 0.200 | 0.0100 |
| DATEM | 5.000 | 0.2500 |
| (Admul datem 1953) | | |
| Ca-Carbonate | 68.000 | 3.4000 |

The dough compositions were prepared at ambient temperature by first mixing and kneading the ingredients except the oil. The oil was added during the last three minutes of the kneading process. In total, the kneading process lasted 10 minutes. The dough was subsequently divided in portions of 85 g.

### Processing

A bread was prepared from the dough compositions according to table 1. A dough of 85 g weight prepared as described above was proved at 34° C. for 60 minutes, then flattened and set on a pastry break and allowed to rest for 10 minutes.

The dough was then proved for 50 minutes at 34° C. and pre-baked for 13 minutes at 200° C. prior to be cooled down to ambient temperature for 30 minutes. The dough was submitted to blast-freezing at −30° C., packed in plastic and stored at −18° C. The final bread was obtained by baking the dough at 180° C. for 6 minutes. The bread was then cooled down to ambient temperature over 30 minutes.

### Flavor Capsules

The bread dry flavour (Givaudan 611049H) was coated by the supplier with hydrogenated (hardened) coconut fat having a slip melting point between 32-34° C. The flavour particle size was 0.5-1 mm.

### Preparation of a Snack

A bread prepared according to the above example was cut in halves. Using a fine sieve having sieve holes of 1 mm 0.5-1.5 g encapsulated flavour particles were distributed over the insides of the 2 halves of bread. Both halves were spread with green pesto. Then, a layer of iceberg salad leaves was put on one half, followed by a layer of grilled paprika slices, a layer of grilled chicken (5 mm thick slices), and a layer of iceberg salad leaves. The other half of the bread was placed on the top of the iceberg salad layer.

### Storage and Stability of the Snack

The packaged bread snack as prepared above was placed in a hard plastic tray of suitable shape and sealed with a flexible black foil. After cooled (<10° C.) storage for 3 days, appearance and taste were assessed and judged to be of same quality as those of a similar sandwich prepared at the test day.

### Evaluation

An organoleptic panel (n=20) has detected improved taste (n=17) in the bread with the flavour capsules in comparison to a non-flavoured bread as well as a bread flavoured with the same kind of flavour, but not-encapsulated. A significant preference was given to the bread with the encapsulated flavour (n=15).

### EXAMPLE 2

Example 1 was repeated, using different flavour particles. Basil flavour (IFF 15.04.0877) was coated with hardened palm fat (Loders Crocklaan PO58) having a slip melting point of 58° C. The flavour particle size is less than 1 mm. An organoleptic panel (n=20) has given a significant preference to the bread with the encapsulated flavour (n=16).

### EXAMPLE 3

Example 1 was repeated, using different flavour particles. The black olive flavour (Dragoco 9/042288) was coated with partially hydrogenated vegetable fat (Loders Crocklaan, Cotebar S). An organoleptic panel (n=20) has given a significant preference to the bread with the encapsulated flavour (n=14).

1. A packaged bread snack, comprising a package having therein a piece of bread which is cut into two halves and having a filling situated between the halves, said filling comprising one or more types of vegetables and one or more ingredients chosen from the group consisting of cheese, fish, meat and pesto, characterized in that it comprises flavour particles, encapsulated with a fatty material.

2. A packaged bread snack according to claim 1, characterised in that the fatty material has a melting point of 25-160° C., preferably 30-70° C.

3. A packaged bread snack according to claim 1, characterized in that the fatty material has a melting point of 30-40°C.

4. A packaged bread snack according to claim 1, characterized in that the fatty material has a percentage solid content at 20° C. of at least 30.

5. A packaged bread snack according to any one of the claim 1, characterized in that the fatty material has a percentage solid content at 50° C. of less than 10.

6. A packaged bread snack according to claim 1, characterized in that the flavour is a bread, a basil, herb, cheese, olive, pesto, tomato, sun dried tomato, fish, e.g. salmon, tuna or meat flavour, or mixtures thereof.

7. A packaged bread snack according to claim 6, wherein the cheese flavour is mozzarella, Parmesan, Gorgonzola or pardena.

8. A packaged bread snack according to claim 1, characterized in that the particle size of the flavour particles is from 0.01 mm to 10 mm.

9. A bread snack according to claim 1, characterized in that the fatty material which is used for the encapsulation is selected from triglycerides, wax esters and sterols.

10. A packaged bread snack according to claim 1, characterised in that the amount of flavour particles, calculated on the total weight of the snack, is from 0.01 to 5%.

11. A bread snack according to claim 1, characterized in that the bread is soft crust ciabatta bread.

12. A bread snack according to claim 1, characterized in that its composition comprises one or more edible emulsifiers.

13. A bread snack according to claim 12, characterized in that the emulsifier is chosen from the group consisting of diacetyl tartaric acid esters of glycerides (DATA) and diacetyl tartaric acid esters of monoglycerides (DATEM).

14. A bread snack according to claim 13, characterized in that the amount of DATA and/or DATEM is 0.05-0.5%, preferably 0.1-0.3%.

15. A bread snack according to claim 1, characterized in that the snack's package is shaped as an at least partially transparent and shallow tray, for the major part consisting of a stiff, rigid material, preferably consisting of a thermoformed polyethylene polyester plastic.

16. A bread snack according to claim 15, characterized in that the snack's package by its form tightly fits to the bread snack.
